(19) United States
(12) Patent Application Publication
(10) Pub. No.: US 2004/0153652 A1
(43) Pub. Date: Aug. 5, 2004

(54) Method, apparatus, system, and program for creating ring signature

(75) Inventor: Yuji Suga, Ohta-ku (JP)

Correspondence Address: Canon U.S.A. Inc., Intellectual Property Department, 15975 Alton Parkway, Irvine, CA, 92618-3731, US

(73) Assignee: Canon Kabushiki Kaisha, Ohta-ku (JP)

(21) Appl. No.: 10/761,697

(22) Filed: Jan. 20, 2004

(30) Foreign Application Priority Data
Jan. 24, 2003 (JP) 2003/016718

(51) Int. Cl. H04L 9/00

(52) U.S. Cl. 713/176

(57) ABSTRACT

Ring signature data that can be created with N public keys and a private key corresponding to one of the N public keys, that allows for signature verification for each of the N public keys, and that allows which one of N members has signed to be kept secret is input. Denial data, which allows for verification that a user other than the creator of the ring signature data has not signed, is created in accordance with the ring signature data. Whether a predetermined verification equation is satisfied is verified in accordance with the generated denial data. If it is satisfied, the user is proven not to be the creator. Thus, the user who has the private key for a public key used without authorization can prove that he or she has not signed.

### BACKGROUND OF THE INVENTION

1. Field of the Invention

The present invention relates to a technology for generating ring signature data for input digital data.

2. Description of the Related Art

Document data and image data communicated over wide-area networks, such as the Internet, are susceptible to tampering by a third party, because of the ease of modification of digital data. Accordingly, in order to allow a recipient to determine whether or not transmitted data has been tampered with, digital signature technology for verifying accompanying data for tamper protection has been proposed. The digital signature technology not only provides protection against data tampering but also offers the advantage of preventing forgery on the Internet and signature denial/repudiation.

[Digital Signature]

A hash function and public key encryption are used for generating digital signature data. Suppose a sender performs hash processing on input data M to compute constant-length data H(M) and then converts the constant-length data H(M) using a private key Ks to create digital signature data S. Thereafter, the sender transmits the digital signature data S and the input data M to a recipient.

The recipient then verifies whether or not data converted (decoded) from the digital signature data S using a public key Kp matches the data provided by hash-processing the input data M. When the result of the verification does not indicate a match, it can be detected that the data M was tampered with.

Public key cryptosystems, such as RSA and DSA, are used for digital signatures. The security of signatures depends on the discrete logarithm problem, which makes it impossible for an entity other than the owner of a private key to forge a signature or to mathematically decrypt the private key.

[Hash Function]

The hash function will now be described. The hash function is used, for example, to speed up the generation of digital signature data. The hash function serves to process data M with an arbitrary length to generate output data with a constant length. The output H(M) will herein be referred to as the “digest data” of plain-text data M.

In particular, when data M is given, one-way hash functions have the property of making it mathematically infeasible to compute plain-text data M′ that satisfies H(M′)=H(M). As such one-way hash functions, MD2, MD5, SHA-1, and the like are typically known and these algorithms are made publicly available.

[Public Key Encryption]

Public-key encryption will now be described. Public key encryption uses two different keys, and has the property that data encrypted with one, key is decrypted only with the other key. One of the pair is called a public key, which is widely distributed. The other key is called a private key, which is kept in possession of the owner.

For a digital signature employing the public-key encryption scheme, some technologies for keeping the signer anonymous have been developed. As examples thereof, a group signature and a ring signature are described below.

[Group Signature]

A group signature, which was introduced by Chaum in 1991, allows anyone to verify which member of a group created a signature, but keeps which individual in the group attached the signature unidentified. The group signature has a scheme that allows a manager, who has a special privilege, other than the members to identify the signer using a special technique when a problem arises.

The group signature scheme can be divided into two main classes: (a) a public-key-registration scheme in which the group's public key contains a list of the public keys of the group members, and (b) a certificate-issuing scheme in which membership certificates are issued to the group members.

With scheme (a), the size of the group's public key and the size of the signature depend on the number of members, which is inefficient. However, excluding a member from the group is simple.

With scheme (b), while the size of the group's public key and the size of the signature are independent of the number of members, a certificate once issued needs to be revoked to exclude a member.

The group signature is used in applications in which a user's privacy must be protected, including electronic payment protocols and electronic auction protocols.

[Ring Signature]

The group signature scheme allows an individual to prove his or her group membership without revealing his or her own identity, but requires a manager having a privilege, other than the members. On the other hand, the ring signature scheme, which was proposed by Shamir et al. in 2001, requires neither such a manager nor any preliminarily arrangement with members to create a signature.

[Ring Signature by Shamir et al.]

Suppose a trap-door one-way function having an input and an output {0, 1}¹ is g_{—}0, . . . , g_(n−1). Let ( ) be a typical hash function and let E_K( ) and D_K( ) be an encryption function and a decryption function, respectively, for encryption/decryption of a symmetric key K. A signature creator holds the inverse function of g_i for a given i in a secret manner. Here, xor represents the exclusive OR operation.

[Shamir Ring Signature: Signature Creation]

The procedure for creating a signature for document M will now be described.

1. Let K:=H(M)

2. Choose Z_{—}0 from {0, 1}¹ at random

3. For j=0, . . . , i−1 (in ascending order), repeat the following: choose r_j from {0, 1}¹ at random and let y_j:=g_j(r_j), z′_j:=z_j xor y_j, and z_(j+1):=E_K (z′_j)

4. z′_(n+1):=D_K(Z_{—}0)

5. For j=n−1, . . . , i+1 (in descending order), repeat the following: choose r_j from {0, 1}¹ at random and let y_j:=g_j(r_j), z_j:=z′_j xor y_j, and z_(j−1):=D_K(z′_j)

6. A signer who knows the inverse function of g_i computes the following: y_i:=z_i xor z′_i, and r_i:=g_i⁻¹(y_i)

7. Output signature (z_{—}0, r_{—}0, r_{—}1, . . . , r_(n−1))

[Shamir Ring Signature: Signature Verification]

The procedure for verifying signature (z_{—}0, r_{—}0, r_{—}1, . . . , r_(n−1)) for document M will be described.

1. Let K:=H(M)

2. For j=0, . . . , n−1 (in ascending order), repeat the following: let y_j:=g_j(r_j), z′_j:=z_j xor y_j, and z_(j+1):=E_K(z′_j)

3. Verify whether z_n=z_{—}0 is satisfied.

The above-described procedure has an advantage in that it is applicable to various existing signature schemes, but requires secure provision of both (a) a trap-door one-way function and (b) symmetric-key encryption and decryption functions.

[Ring signature by Okubo et al.]

In order to overcome the above-noted problem, a signature scheme that does not require the functions (a) and (b) has been proposed. This signature scheme, however, is used only for an existing signature system called Schnorr signature and is thus limited in application.

[Schnorr Signature]

A description is now given of the Schnorr signature (see, for example, C. P. Schnorr, “Efficient Signature Generation by Smart Cards”, Journal of Cryptology, Vol. 4, No. 3, pp.161-174, (1991)).

Let p and q be prime numbers, where p−1 is divided by q. Also, g is a generator of order q, the generator being randomly chosen from Z_p* (a multiplicative group obtained by removing 0 from cyclic group Z_p of order p). Let x be a private key chosen from Z_p* and set a public key y corresponding thereto such that y:=g^{x} mod p. H( ) is a hash function.

[Schnorr Signature Creation]

A procedure for creating a signature for document M will now be described.

1. Choose α from Z_q at random and let T:=g^{α} mod p

2. Let c:=H(M ∥ T), where ∥ represents data coupling

3. Let s:=α−xc mod q and let (s, c) be signature data

[Schnorr Signature Verification]

Verification Procedure for Signature (s, c) for Document M will be described.

Let T:=g^{s}y^{c} mod p and verify whether c=H(M ∥ T) is satisfied.

The ring signature proposed by Okubo et al. can be regarded as a sequential coupling of Schnorr signatures.

A description is now given of a ring signature according to the Schnorr signature (see, for example, Okubo, Abe, Suzuki, and Tsujii, “1-out-of-n Proof with Decreased Proof Length (Shoumeichou-ga-mijikai 1-out-of-n Shoumei)”, 4C-4, pp.189-193, 2002, Symposium on Cryptography and Information Security (SCIS2002)).

The same terminology is used hereinbelow as that for the Schnorr signature. A signer has n public keys y_i (for g_i, p_i, and q_i). Suppose the signer knows a private key x_i for y_i of the n public keys. H_i( ) is a hash function. The indices are taken mod n. For example, suppose x_(n+1) is x_{—}0.

[Schnorr Ring Signature Creation]

The procedure for creating a signature for document M will now be described.

1. Select ax from Z_(q_i) at random and let T_i:=g_i^{α} mod p_i

2. Let c_(i+1):=H(M ∥ T_i)

3. For j=i+1, . . . , i−1 (in ascending order), repeat the following: select s_j from Z_(q_j) at random and let T_j:=g_j^{s}^{_{—}}^{j}y_j^{c}^{_{—}}^{j} mod p_j,c_(j+1):=H(M ∥ T_j)

4. Let s_i:=α−x_i c_i mod q_i and let (c_{—}0, s_{—}0, s_{—}1, . . . , s_(n−1)) be signature data

[Schnorr Ring Signature Verification]

The procedure for verifying the signature (c_{—}0, s_{—}0, s_{—}1, . . . , s_(n−1)) for document M will now be described.

1. For j=0, . . . , n−1 (in ascending order), repeat the following: let T_j:=g_j^{s}^{_{—}}^{j}y_j^{c}^{_{—}}^{j} mod p_j, and c_(j+1):=H(M ∥ T_j)

2. Verify whether c_n=c_{—}0 is satisfied

The ring signature by Shamir et al. and the Schnorr ring signature by Okubo et al. do not require a manger, and therefore, anonymity is ensured by freely obtaining the public key of a third party and by attaching a pseudo signature. Those schemes, however, can include a pseudo signature in a ring by simply obtaining the public key of a third party, but this is susceptible to unauthorized use of the public key. In such a case, a problem arises in that a user holding a private key corresponding to the public key used without authorization cannot prove that the user did not sign, in other words, the user cannot deny that the user signed.

Specific examples of ring signature applications include whistle blowing to media organizations. Ring signatures are useful in that a whistle blower can ensure the document's credibility without revealing his or her own identity. However, there is a risk that someone other than the whistle blower, who is included in the ring signature, may be suspected regardless of the fact that he or she is not the whistle blower. In this case, there are no effective measures the user can use to prove to a third party that the document was not signed by the user.

### SUMMARY OF THE INVENTION

Accordingly, an object of the present invention is to provide a technology for proving that a user holding a private key corresponding to a public key used without authorization has not created a signature therewith.

To this end, the present invention allows for creation of denial data indicating that the signature was not created. Yet, it is necessary to prevent the signer of a ring signature from creating the denial data. In the above-described example, if an actual whistle blower can prove to a third party that “the document was not signed by oneself,” then others who have not denied the signature are suspected accordingly.

Thus, another object of the present invention is to make it impossible for the signer of a ring signature to create denial data.

According to one aspect, the present invention which achieves these objects relates to a ring signature creating apparatus. The apparatus includes a signature-data inputting section for inputting ring signature data that can be created with N public keys and a private key corresponding to one of the N public keys, that allows for signature verification for each of the N public keys, and that allows which one of N members has signed to be kept secret. The apparatus further includes a denial data generating section for generating denial data in accordance with the ring signature data, the denial data allowing for verification that a user other than a creator of the ring signature data has not signed.

According to another aspect, the present invention which achieves the above-described objects relates to a ring signature creating apparatus in a digital signature system in which, when a message is digitally signed, pre-computed data is compressed together with the message with a hash function. The apparatus includes a hash computing section for generating first pre-computed data and computing an i-th hash value for data that has N public keys and at least one private key corresponding to the N public keys and that includes the message and an i-th pre-computed data. The apparatus further includes a pseudo computing section for computing the i-th pre-computed data and an i-th signature data such that the i-th hash value appears to have been signed, and a signing section for generating first signature data corresponding to the first pre-computed data from the private key, with respect to an N-th hash value obtained through sequential computing by the pseudo computing section.

According to still another aspect, the present invention which achieves the above-described objects relates to a ring signature verifying apparatus in a digital signature system in which, when a message is digitally signed, pre-computed data is compressed together with the message with a hash function. The apparatus includes a hash computing section for computing an i-th hash value for data that has N public keys and that includes the message and an i-th pre-computed data, and a verification computational-operation section for performing a computational operation for verification of an i-th signature data. The apparatus further includes a verifying section for verifying whether an N-th hash value matches a first hash value, the N-th hash value being obtained through sequential computation by the verification computational-operation section.

According to a further aspect, the present invention which achieves the above-described objects relates to a ring signature creating method. The method includes an inputting step of inputting ring signature data that can be created with N public keys and a private key corresponding to one of the N public keys, that allows for signature verification for each of the N public keys, and that allows which one of N members has signed to be kept secret. The method further includes a denial data generating step of generating denial data in accordance with the ring signature data, the denial data allowing for verification that a user other than a creator of the ring signature data has not signed.

According to a further aspect, the present invention which achieves the above-described objects relates to a ring signature creating method in a digital signature system in which, when a message is digitally signed, pre-computed data is compressed together with the message with a hash function. The method includes a hash computing step of generating first pre-computed data and computing an i-th hash value for data that has N public keys and at least one private key corresponding to the N public keys and that includes the message and an i-th pre-computed data. The method further includes a pseudo computing step of computing the i-th pre-computed data and an i-th signature data such that the i-th hash value appears to have been signed, and a signing step of generating first signature data corresponding to the first pre-computed data from the private key, with respect to an N-th hash value obtained through sequential computing in the pseudo computing step.

According to a further aspect, the present invention which achieves the above-described objects relates to a ring signature verifying method in a digital signature system in which, when a message is digitally signed, pre-computed data is compressed together with the message with a hash function. The method includes a hash computing step of computing an i-th hash value for data that has N public keys and that includes the message and an i-th pre-computed data, and a verification computational-operation step of performing a computational operation for verification of an i-th signature data. The method further includes a verifying step of verifying whether an N-th hash value matches a first hash value, the N-th hash value being obtained through sequential computation in the verification computational-operation step.

Other objectives and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing the configuration of an apparatus for creating and verifying a ring signature.

FIG. 2 is a schematic diagram showing a functional configuration for creating denial data for a ring signature.

FIG. 3 is a flow chart depicting processing steps for creating the denial data.

FIG. 4 is a flow chart depicting protocol processes for interactive denial.

### DESCRIPTION OF THE PREFERRED EMBODIMENTS

Preferred embodiments according to the present invention will now be described in detail with reference to the accompanying drawings.

### First Embodiment

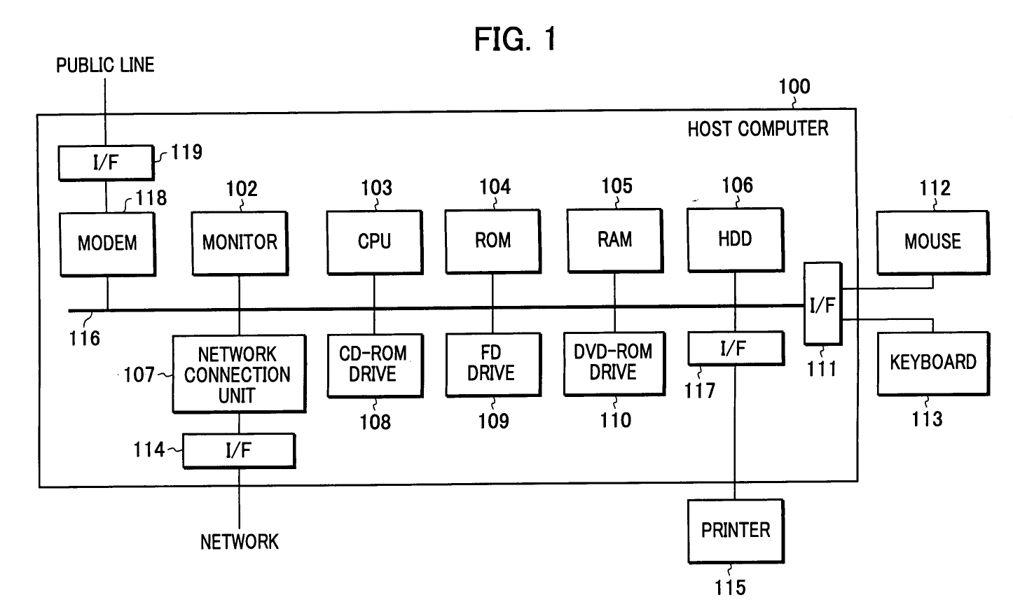

For example, a computer having the basic configuration shown in FIG. 1 can be applied to an apparatus for executing a ring-signature creating process and a ring-signature verifying process according to a first embodiment. The basic configuration of this computer will now be described with reference to FIG. 1.

As shown in FIG. 1, this computer 100 includes a modem 118 connected to a public line or the like, a monitor 102 serving as a display unit, a CPU (central processing unit) 103, a ROM (read only memory) 104, a RAM (random access memory) 105, an HDD (hard disk drive) 106, a network connection unit 107 for a network, a CD-ROM drive 108, an FD (floppy disk) drive 109, and a DVD-ROM (digital video/versatile disc read-only memory) drive 110. The computer 100 further includes and an interface (I/F) 117 for a printer 115 and an interface (I/F) 111 for a mouse 112 and a keyboard 113. The units mentioned above are interconnected via a bus 116 so as to allow communication between the devices.

The mouse 112 and the keyboard 113 serve as operation units that allow a user to give various instructions and the like to the computer 100. Information (operational information) input through the operation units is sent to the CPU 103 via the interface 111.

Various types of information (e.g., character information and image information) stored on the computer 100 can be printed out by the printer 115.

The monitor 102 is implemented with a CRT (cathode ray tube) display, an LCD (liquid crystal display), or the like to display various types of information, including character information, image information, and instruction information for a user.

The CPU 103 serves to control the entire operation of the computer 100, and executes a ring-signature creating process and a ring-signature verifying process, which are described below. The CPU 103 also performs various processes by executing various processing programs (software programs) loaded into the RAM 105 from, for example, the HDD 106, the CD-ROM drive 108, the FD drive 109, and the DVD-ROM drive 110.

The ROM 104 stores various types of data and various processing programs, such as a program for creating/verifying a signature.

The RAM 105 has, for example, a work area for temporarily storing a processing program and information to be processed by the CPU 103.

The HDD 106 is one example of a large-capacity storage device to store, for example, character information and image information, as well as various information-conversion processing programs to be transferred to the RAM 105 and the like during execution of various processes.

The CD-ROM drive 108 has a function for reading data stored on a CD-ROM or CD-R, which are examples of external storage media, and also has a function for writing data to a CD-R.

The FD drive 109 reads data stored on an FD (floppy disk), which is one example of an external storage medium. The FD drive 109 also has a function for writing various types of data to the FD.

The DVD-ROM drive 110 reads data stored on a DVD, which is one example of an external storage medium, and also has a function for writing data to the DVD.

For example, when an editing program or a printer driver is stored on an external storage medium, such as a CD, FD, or DVD, the arrangement may be such that these programs are installed on the HDD 106 so as to be transferred to the RAM 105 as needed.

The interface (I/F) 111 receives an input from the user through the mouse 112 or the keyboard 113.

The modem 118 is a communication modem and is connected to an external network through the interface (I/F) 119 and a public line or the like.

The network connection unit 107 is connected to an external network via the interface (I/F) 114.

While the computer having the above-described configuration executes a ring-signature creating process and a ring-signature verifying process, a single apparatus or a plurality of apparatuses may be used to execute the individual processes.

A process for creating denial data for a ring signature will now be described.

[Denial Data Creation]

A description is now given of a procedure for creating denial data for a Schnorr ring signature. Suppose a denial-data creator holds secret key x_i for public key y_i.

1. Let α*:=s_i+x_i c_i

2. Choose r from Z_(q_i) at random. Let T*:=g_i^{r} and let c_i*:=H(M ∥ T* ∥ T_(i−1) ∥ Rep), where Rep is pledge data indicating denial.

3. Let s_i*:=r−α* c_i* mod q_i and create denial data (s_i*, c_i*) for ring signature (c_{—}0, s_{—}0, s_{—}1, . . . , s_(n−1))

[Denial Data Verification]

A description is now given of a procedure for verifying the denial data for a Schnorr ring signature. For denial data (s_i*, c_i*), let T*:=g_i^{s}^{_{—}}ⁱ*T*^{c}^{_{—}}ⁱ* mod p_i and verify whether the equation c_i*=H(M ∥ T* ∥ T_(i−1) ∥ Rep) is satisfied.

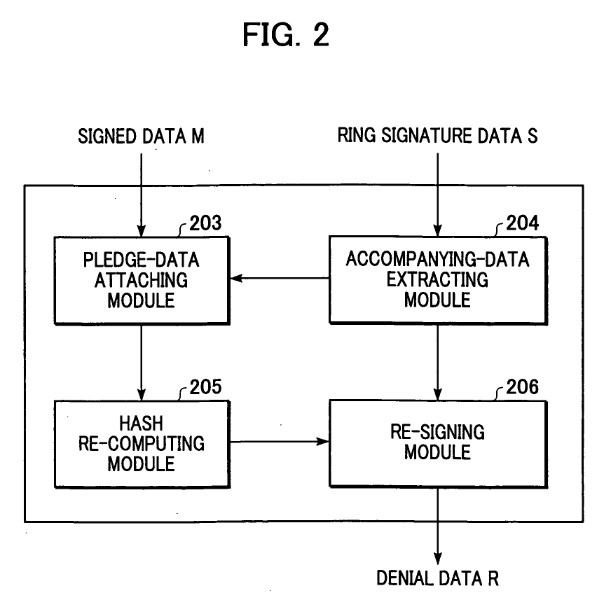

FIG. 2 is a schematic diagram showing the functional configuration of an apparatus for creating the denial data for a ring signature or a program for causing a computer to create the denial data for a ring signature. In this embodiment, the functions of individual modules shown in FIG. 2 are realized by a program which is loaded into and executed by the computer 100.

A denial-data creator stores secret key x_i for public key y_i on, for example, the HDD 106, a CD-ROM, an FD, or a DVD-ROM, which is connected to the computer 100, so that the secret key x_i can be loaded into the RAM 105 as needed.

In order to perform the first process for creating the denial data, ring signature data S is input, and an accompanying-data extracting module 204 extracts s_i and c_i from ring signature data S. The equation α*:=s_i+x_i c_i is computed based on the extracted s_i and c_i and the secret key x_i.

In order to perform the second process for creating the denial data, r is chosen at random from Z_(q_i) and T*:=g_i^{r} is computed. Upon input of signed data M, the accompanying-data extracting module 204 extracts T_(i−1). A pledge-data attaching module 203 then attaches T_(i−1) and pledge data Rep to the signed data M, and passes the resulting data to a hash re-computing module 205, which computes the equation c_i*:=H(M ∥ T* ∥ T_(i−1) || Rep), where Rep is pledge data indicating denial.

In order to perform the third process for creating the denial data, a re-signing module 206 computes s_i*:=r−α* c_i* mod q_i, based on α* obtained from the accompanying-data extracting module 204 and c_i* obtained from the hash re-computing module 205, and consequently outputs denial data R=(s_i*, c_i*).

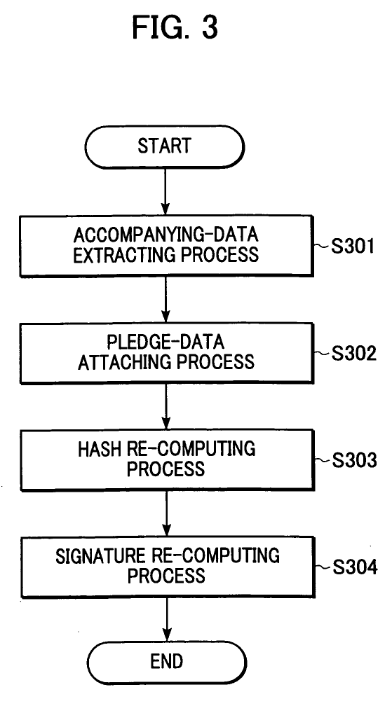

FIG. 3 is a flow chart depicting processes for creating the denial data. Since processes at the individual steps have been described above, a simple description is given of those steps hereinafter. A program according to the flow chart shown in FIG. 3 is loaded into the RAM 105 through the HDD 106, the CD-ROM drive 108, the FD drive 109, the DVD-ROM drive 110, or the like. The loaded program is executed by the CPU 103 so that the computer 100 can execute the processes shown in the flow chart of FIG. 3, i.e., the processes for creating the denial data.

The accompanying-data extracting module 204 performs an accompanying-data extracting process in step S301 and the pledge-data attaching module 203 performs a pledge-data attaching process in step S302. Further, the hash re-computing module 205 performs a hash re-computing process in step S303 and the re-signing module 206 performs a signature re-computing process in step S304.

That is, the denial is declared by replacing forged signature s_i included in ring signature (c_{—}0, s_{—}0, s_{—}1, . . . , s_(n−1)) with s_i*. An operation for creating this s_i* can be performed only by the owner of private key x_i for public key y_i. This is because the first process for creating the denial data is executed only by the owner of private key x_i and the third process is the same as a typical signing operation, so that s_i* can be computed only by the owner of secret data α*.

In the computation of c_i* in this embodiment, T_(i−1) and Rep are included in data that is passed to the hash function, but are not necessarily have to be included therein. Re-signing with secret data α* obtained from the first process provides a proof for security. Thus, the calculation of c_i* can have many other variations as to what is subjected to the hash computation.

### Second Embodiment

While the system for off-line verification of the created denial data has been discussed in the first embodiment, an interactive denial protocol will be described in a second embodiment.

[Protocol between User U Issuing Denial and Verifier V Verifying the Denial]

1. A verifier (user) V sends ring signature (c_{—}0, s_{—}0, s_{—}1, . . . , s_(n−1)) and challenge data r to a user U.

2. The user U sends s_i* computed as follows to the verifier: extract s_i and c_i from the ring signature data and let αx*:=s_i+x_i c_i. Then, compute s_i*:=r−α* c_i* mod q_i for c_i*:=H(M ∥ T* ∥ T_(i−1) ∥ r).

3. The verifier V verifies whether the following equation is satisfied: c_i*=H(M ∥ T* ∥ T_(i−1) ∥ Rep) for c_i*:=H(M ∥ T* ∥ T_(i−1) ∥ r). If it is verified that the equation is satisfied, this proves that the user U is not the ring signature creator.

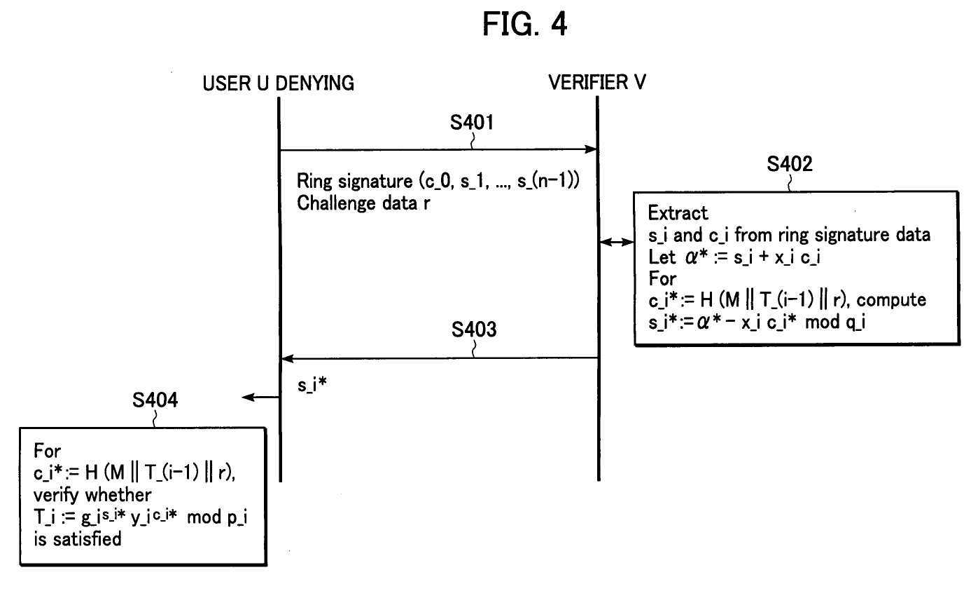

FIG. 4 is a flow chart depicting the processes for the above-described protocol. The protocol process (1) described above is executed in step S401, the protocol process (2) is executed in steps S402 and S403, and the protocol process (3) is executed in step S404.

Although s_i* is transmitted in communication in the protocol described above, a zero knowledge proof protocol may be used to achieve interactive proof. Specifically, since the only person who can compute α* is the owner of private key x_i, g\hat{ }(α*) may be made public so as to allow interactive proof as to whether or not a person has α* corresponding thereto.

### Third Embodiment

While the above-described embodiments are based on the ring signature for a Schnorr signature, a third embodiment will be described in connection with a DSA signature. This embodiment can be applied to other existing signature systems.

[DSA Signature]

A description is now given of the system discussed in Federal Information Processing Standards (FIPS) 186-2, “Digital Signature Standard (DSS)”, January 2000. The same terminology is used hereinbelow as that for the Schnorr signature.

[DSA Signature Creation] Procedure for Creating a Signature for Document M

1. Choose α from Z_q at random and let T:=(g^{α} mod p) mod q

2. Let c:=H(M)

3. Let s:=α⁻¹ (c+xT) mod q and let (s, T) be signature data

[DSA Signature Verification] Procedure for Verifying Signature (s, T) for Document M

Verify whether T=(g^{h(M)\hat{ }-1}y^{Ts\hat{ }-1} mod p) mod q is satisfied.

[DSA Ring Signature Creation] Procedure for Creating a Signature for Document M

1. Choose α from Z_(q_i) at random and let T_i:=(g_i^{α} mod p_i) mod q_i

2. Let c_(i+1):=H(M ∥ T_i)

3. For j=i+1, . . . , i−1 (in ascending order), repeat the following: choose s_j from Z_(q_j) at random and let T_j:=g_j^{c}^{_{—}}^{js}^{_{—}}^{j\hat{ }-1}y_j^{T}^{_{—}}^{js}^{_{—}}^{j\hat{ }-1} mod p_j and c_(j+1):=H(M ∥ T_j)

4. Let s_i:=α⁻¹(c_i+x_i T_i) mod q and let (c_{—}0, s_{—}0, s_{—}1, . . . , s_(n−1)) be signature data

[DSA Ring Signature Verification] Procedure for Verifying Signature (c_{—}0, s_{—}0, s_{—}1, . . . , s_(n−1)) for Document M 1. For j=0, . . . , n−1 (in ascending order), repeat the following: let T_j:=g_j^{c}^{_{—}}^{js}^{_{—}}^{j\hat{ }-1}y_j^{T}^{_{—}}^{js}^{_{—}}^{j\hat{ }-1} mod p_j and c_(j+1):=H(M ∥T_j).

2. Verify whether c_n=c_{—}0 is satisfied

Other than the above-described method, a method for chaining T_i may also be used rather than chaining c_i.

### Fourth Embodiment

While the pledge data Rep is required in the above embodiments, an example in which pre-computed data T_j is substituted therefor will be described. In the second operation for creating the denial data in the first embodiment, for example, T_j (j≠i) can also be substituted for c_i*:=H(M ∥ T_(i−1) ∥ Rep) such that c_i*:=H(M ∥ T_(i−2)) without the use of Rep.

In addition, a plurality of ring signatures for a single message can be created so that they are included in data to be hashed. For example, when two ring signatures are created, first, first ring signature data (c_{—}0, s_{—}0, s_{—}1, . . . , s_(n−1)) in which Rep is also hashed such that H(M ∥ T_i ∥ Rep) is satisfied. Next, let R_{—}1:=H((c_{—}0, s_{—}0, s_{—}1, . . . , s_(n−1))), and second ring signature data is created such that H(M ∥ T_i ∥ R_{—}1) is satisfied. When made public, Rep is kept secret and R_{—}1 and the second ring signature data are made public. After being made public, when there is an entity wishing to create a denial signature, the first ring signature data and Rep are made public, so that α* is computed from the respective first ring signature data and the second ring signature data, thereby allowing the creation of denial signature data.

### Other Embodiments

The above-described object of the present invention can also be achieved by a storage medium (or recording medium) in which software program code that realizes the features of the illustrated embodiments. That is, the object of the present invention can be achieved such that a storage medium in which such program code is recorded is supplied to a system or apparatus and a computer (or CPU or MPU) of the system or the apparatus reads and executes the program code. In such a case, the program code that is read from the storage medium achieves the features of the embodiments described above and the storage medium in which the program code is recorded is also encompassed by the present invention.

Further, not only is the program code that is read from the computer executed to achieve the features of the illustrated embodiments, but also an operating system (OS) or the like that is running on the computer may perform part or all of the actual processing in accordance with an instruction of the program code to achieve the features of the illustrated embodiment. Such an arrangement is also covered by the present invention.

Additionally, after the program code that is read from the storage medium is stored in a memory that is provided in a plug-in card inserted into the computer or an expansion unit connected to the computer, a CPU or the like that is provided in the plug-in card or the expansion unit may perform part or all of the actual processing in accordance with an instruction of the program code to achieve the features of the illustrated embodiments. Such an arrangement is also encompassed by the present invention.

When the present invention is applied to the above-noted storage medium, the storage medium stores program code corresponding to the flow charts discussed above.

Although the present invention has been described in its preferred form with a certain degree of particularity, many apparently widely different embodiments of the invention can be made without departing from the spirit and the scope thereof. It is to be understood that the invention is not limited to the specific embodiments thereof except as defined in the appended claims.

What is claimed is:

1. A ring signature creating apparatus, comprising:
signature-data inputting means for inputting ring signature data that can be created with N public keys and a private key corresponding to one of the N public keys, that allows for signature verification for each of the N public keys, and that allows which one of N members has signed to be kept secret; and
denial-data generating means for generating denial data in accordance with the ring signature data, the denial data allowing for verification that a user other than a creator of the ring signature data has not signed.

2. A ring signature creating apparatus in a digital signature system in which, when a message is digitally signed, pre-computed data is compressed together with the message with a hash function, the apparatus comprising:
hash computing means for generating first pre-computed data and computing an i-th hash value for data that has N public keys and at least one private key corresponding to the N public keys and that includes the message and an i-th pre-computed data;
pseudo computing means for computing the i-th pre-computed data and an i-th signature data such that the i-th hash value appears to have been signed; and
signing means for generating first signature data corresponding to the first pre-computed data from the private key, with respect to an N-th hash value obtained through sequential computing by the pseudo computing means.

3. The ring signature creating apparatus according to claim 2, wherein a digital signature system in which a message is digitally signed after only the message is compressed with a hash function is changed to the digital signature system in which the pre-computed data is compressed together with the message with the hash function.

4. The ring signature creating apparatus according to claim 2, further comprising means for creating denial data for the generated ring signature data, the denial data allowing for verification that a user other than a creator of the ring signature data has not signed.

5. The ring signature creating apparatus according to claim 4, further comprising:
message receiving means for receiving a message to be signed;
ring-signature data receiving means for receiving the ring signature data in which a ring signature is attached to the message;
pledge-data attaching means for attaching pledge data to the message;
accompanying-data extracting means for extracting data needed to re-compute a signature from the ring signature data;
re-signing means for re-signing the pledge-data-attached message created by the pledge-data attaching means; and
denial-data outputting means for outputting data computed by the re-signing means.

6. The ring signature creating apparatus according to claim 5, wherein the re-signing means comprises hash re-computing means for re-computing a hash value for data obtained by the pledge-data attaching means and computational-operation means for performing a computational operation on the hash value computed by the hash re-computing means.

7. The ring signature creating apparatus according to claim 5, wherein the pledge data is replaced with pre-computed data.

8. The ring signature creating apparatus according to claim 2, wherein the first pre-computed data is a result of computation in which, with respect to a generator g of a multiplicative group of order P−1, pseudo random number k is generated and a computational operation g\hat{ }k(mod P)is performed, where P is a prime number and k<P−1.

9. The ring signature creating apparatus according to claim 1, wherein security is based on a discrete logarithm problem.

10. The ring signature creating apparatus according to claim 1, wherein the denial data is proven by interactive communication.

11. A ring signature verifying apparatus in a digital signature system in which, when a message is digitally signed, pre-computed data is compressed together with the message with a hash function, the apparatus comprising:
hash computing means for computing an i-th hash value for data that has N public keys and that includes the message and an i-th pre-computed data;
verification computational-operation means for performing a computational operation for verification of an i-th signature data; and
verifying means for verifying whether an N-th hash value matches a first hash value, the N-th hash value being obtained through sequential computation by the verification computational-operation means.

12. The ring signature verifying apparatus according to claim 11, wherein a digital signature system in which, when a message is digitally signed, a computational operation is performed after only the message is compressed with a hash function, is changed to the digital signature system in which the pre-computed data is compressed together with the message with the hash function, and the changed digital signature system is executed.

13. The ring signature verifying apparatus according to claim 11 or 12, further comprising means for generating denial data for the ring signature data generated by the ring signature creating apparatus according to claim 1, the denial data allowing for verification that a user other than a creator of the ring signature data has not signed.

14. The ring signature verifying apparatus according to claim 13, further comprising:
signature-message receiving means for receiving a message to be signed;
ring-signature data receiving means for receiving ring signature data in which a ring signature is attached to the message;
denial-data receiving means for receiving denial data for the ring signature data receiving means;
pledge-data receiving means for receiving pledge data corresponding to the denial data;
accompanying-data extracting means for extracting data needed for verification from the ring signature data;
hash computational-operation means for computing a hash value from the message and the pledge data; and
denial-data verifying means for performing a computational operation on the denial data using the public key to thereby verify whether the resulting denial data matches data obtained by the hash computational-operation means.

15. The ring signature verifying apparatus according to claim 11, wherein security is based on a discrete logarithm problem.

16. The ring signature verifying apparatus according to claim 11, wherein the denial data is proven by interactive communication.

17. A ring signature system, comprising:
the ring signature creating apparatus according to claim 1; and
the ring signature verifying apparatus according to claim 11.

18. A ring signature creating method, comprising:
an inputting step of inputting ring signature data that can be created with N public keys and a private key corresponding to one of the N public keys, that allows for signature verification for each of the N public keys, and that allows which one of N members has signed to be kept secret; and
a denial data generating step of generating denial data in accordance with the ring signature data, the denial data allowing for verification that a user other than a creator of the ring signature data has not signed.

19. A ring signature creating method in a digital signature system in which, when a message is digitally signed, pre-computed data is compressed together with the message with a hash function, the method comprising:
a hash computing step of generating first pre-computed data and computing an i-th hash value for data that has N public keys and at least one private key corresponding to the N public keys and that includes the message and an i-th pre-computed data;
a pseudo computing step of computing the i-th precomputed data and an i-th signature data such that the i-th hash value appears to have been signed; and
a signing step of generating first signature data corresponding to the first pre-computed data from the private key, with respect to an N-th hash value obtained through sequential computing in the pseudo computing step.

20. A ring signature verifying method in a digital signature system in which, when a message is digitally signed, pre-computed data is compressed together with the message with a hash function, comprising:
a hash computing step of computing an i-th hash value for data that has N public keys and that includes the message and an i-th pre-computed data;
a verification computational-operation step of performing a computational operation for verification of an i-th signature data; and
a verifying step of verifying whether an N-th hash value matches a first hash value, the N-th hash value being obtained through sequential computation in the verification computational-operation step.

21. A program for causing a computer to realize the ring signature creating method according to claim 18.

22. A program for causing a computer to realize the ring signature creating method according to claim 19.

23. A program for causing a computer to realize the ring signature verifying method according to claim 20.
